(19) United States
(12) Patent Application Publication
(10) Pub. No.: US 2006/0066913 A1
(43) Pub. Date: Mar. 30, 2006

(54) Printing method and printing system

(75) Inventor: Teruyoshi Nakashima, Asaka-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/235,253

(22) Filed: Sep. 27, 2005

(30) Foreign Application Priority Data
Sep. 27, 2004 (JP) 2004-279760
May 24, 2005 (JP) 2005-151036

(51) Int. Cl. H04N 1/40

(52) U.S. Cl. 358/448

(57) ABSTRACT

According to the present invention, first, images of a particular object to be printed are obtained, and a particular object to be printed is extracted from the obtained images. Then, an image of the extracted object is searched from the images stored in the storage, and the searched image is printed. In this manner, the image of a particular object among the images stored in the storage can be easily printed.

### BACKGROUND OF THE INVENTION

1. Field of the Invention

The present invention relates to a printing method and a printing system, and more specifically to a printing method and a printing system for reprinting an image once printed (reproducing a picture).

2. Related Art

A picture for certificate has specific sizes and forms for each usage. If a person needs a picture for certificate, he usually takes picture of himself in a photo-booth for certificate set on the street or the like or goes to a photo-studio.

Such a photo-booth for certificate, however, has a problem in that the sizes for printing a picture is limited to popular sizes such as a driver's license size or a passport size.

Japanese Patent Application Laid-Open No. 2003-125319 proposes a photo-booth that provides a user with the user's desired number of prints in the size for the purpose.

### SUMMARY OF THE INVENTION

The photo-booth proposed in Japanese Patent Application Laid-Open No. 2003-125319, however, cannot accommodate a request for reprinting a picture at a later date.

The photo-studio can accommodate a request for reprinting a picture at a later date as the studio saves the image data; however, the studio has a problem in that it takes a lot of trouble with managing the image data. In order to reprint a picture, they have to search and read out the image data to be printed from the storage at the studio. It is troublesome for them to get private information for identifying the user including the user's name, birth date and telephone number.

The present invention is adapted in view of the problems and intends to provide a printing method and a printing system for enabling a user to easily have a once printed image to be reprinted.

To achieve the abovementioned intention, the first aspect of the present invention provides a printing method for printing an image of a particular object from images stored in storage, comprising the steps of obtaining an image of a particular object to be printed, extracting the particular object from the obtained image, searching an image of the extracted object from images stored in the storage, and printing the searched image.

According to the first aspect, first, images of a particular object to be printed are obtained, and a particular object to be printed is extracted from the obtained images. Then, an image of the extracted object is searched from images stored in the storage, and the searched image is printed. In this manner, the image of a particular object among the images stored in the storage can be easily printed.

To achieve the abovementioned intention, the second aspect of the present invention provides a printing method for printing an image of a particular object from images stored in storage, comprising the steps of obtaining a plurality of images of particular objects to be printed, extracting each of the particular objects from the plurality of obtained images, searching an image of all the extracted objects from images stored in the storage, and printing the searched image.

According to the second aspect, first, a plurality of images of particular objects to be printed are obtained, and each of the particular objects is extracted from the plurality of obtained images. Then, an image of all the extracted objects is searched from the images stored in the storage, and the searched image is printed. In this manner, the images of particular objects among the images stored in the storage can be easily printed.

To achieve the abovementioned intention, the third aspect of the present invention provides a printing method for printing an image of a particular object from images stored in storage, comprising the steps of obtaining a plurality of images of particular objects to be printed, extracting each of the particular objects from the plurality of obtained images, searching images stored in the storage for an image of at least one of the extracted objects, and printing the searched image.

According to the third aspect, first, a plurality of images of particular objects to be printed are obtained, and each of the particular objects is extracted from the plurality of obtained images. Then, an image of at least one of the extracted objects is searched from the images stored in the storage, and the searched image is printed. In this manner, the image of a particular object among the images stored in the storage can be easily printed.

To achieve the abovementioned intention, the fourth aspect of the present invention provides the printing methods of the first to the third aspects, wherein an image is added with information on shooting date and time and stored in the storage so that an image is searched by an indication of a period of shooting dates and times.

According to the fourth aspect, an image can be searched by an indication of a period of shooting dates and times.

To achieve the abovementioned intention, the fifth aspect of the present invention provides the printing methods of the first to the fourth aspects, wherein an image of a particular object to be printed is obtained by being taken by digital camera.

According to the fifth aspect, an image of a particular object to be printed is obtained from a digital camera.

To achieve the abovementioned intention, the sixth aspect of the present invention provides the printing methods of the first to the fourth aspects, wherein an image of a particular object to be printed is obtained by being read by scanner.

According to the sixth aspect, an image of a particular object to be printed is obtained from a scanner.

To achieve the abovementioned intention, the seventh aspect of the present invention provides the printing methods of the first to the fourth aspects, wherein an image of a particular object to be printed is obtained by being read from a storage medium.

According to the seventh aspect, an image of a particular object to be printed is obtained from a storage medium.

To achieve the abovementioned intention, the eighth aspect of the present invention provides the printing methods of the first to the seventh aspects, wherein an image to be stored in the storage is a once printed image.

According to the eighth aspect, a once printed image is recorded on storage and accumulated.

To achieve the abovementioned intention, the ninth aspect of the present invention provides a printing method for printing an image taken by digital camera, comprising the steps of storing an image taken by digital camera in storage, generating information for identifying the image stored in the storage, printing the image taken by the digital camera together with the generated information for printing the image for the first time, and comprising the steps of reading the information added to the print and identifying the image to be printed stored in the storage, and reading out and printing the identified image from the storage for reprinting the image.

According to the ninth aspect, when an image is printed for the first time, the image taken by digital camera is stored in storage and the image is printed together with information for identifying the image stored in the storage. When the image is reprinted, information added to the print is read and the image to be printed stored in storage is identified, and the identified image is read out from the storage and printed. In this manner, an image to be reprinted can be easily identified and reprinting tasks can be performed easily and smoothly.

To achieve the abovementioned intention, the tenth aspect of the present invention provides the printing methods of the first to ninth aspects, wherein a stored period of an image in the storage is clocked, and when the stored period is over a certain period, the image is deleted from the storage as an expired image.

According to the tenth aspect, when an image stored in storage is expired, the image is automatically deleted from the storage. In this manner, the present invention can prevent unnecessary image data from occupying a part of capacity of storage.

To achieve the abovementioned intention, the eleventh aspect of the present invention provides the printing method of the tenth aspect, wherein information to be added to the print includes information on expiration of the image.

According to the eleventh aspect, information to be added to the print includes information on expiration of the image. In this manner, the present invention enables whether an image is expired or not is determined easily.

To achieve the abovementioned intention, the twelfth aspect of the present invention provides the printing methods of the first to the eleventh aspects, wherein the size and number to be printed are designated and the image is printed in the designated size and number.

According to the twelfth aspect, the size and number of an image to be printed can be designated for printing the image. In this manner, the prints can be easily obtained in the necessary size and the necessary number.

To achieve the abovementioned intention, the thirteenth aspect of the present invention provides a printing system for printing an image of a particular object from images stored in storage, comprising an inputting device for inputting an image of a particular object to be printed, an extracting device for extracting the particular object from the image inputted by the inputting device, a searching device for searching an image of the object extracted by the extracting device from images stored in the storage, and a printing device for printing the image searched by the searching device.

According to the thirteenth aspect, when an image of a particular object to be printed is inputted by an inputting device the particular object to be printed is extracted by an extracting device. Then, an image of the particular object extracted by the extracting device is searched from images stored in storage by a searching device and the searched image is printed by the printing device. In this manner, the image of a particular object can be easily printed from the images stored in storage.

To achieve the abovementioned intention, the fourteenth aspect of the present invention provides the printing system of the thirteenth aspect, wherein when a plurality of images are inputted by the inputting device, the searching device searches an image of all the objects extracted by the extracting device from the images stored in the storage.

According to the fourteenth aspect, when a plurality of images are inputted by an inputted device, an object to be printed is extracted from each of the images by an extracting device. Then, an image of all the objects extracted by an extracting device is searched from the images stored in storage by a searching device.

To achieve the abovementioned intention, the fifteenth aspect of the present invention provides the printing system of the thirteenth aspect, wherein when a plurality of images are inputted by the inputting device, the searching device searches an image of at least one of objects extracted by the extracting device from the images stored in the storage.

According to the fifteenth aspect, when a plurality of images are inputted by the inputting device, an object to be printed is extracted from each of the images by an extracting device. Then, an image of at least one of objects extracted by the extracting device is searched from the images stored in storage by a searching device.

To achieve the abovementioned intention, the sixteenth aspect of the present invention provides the printing system of the thirteenth to fifteenth aspects, further comprising a shooting period inputting device for inputting a shooting period when an image is added with information on the shooting date and time and stored in the storage, wherein the searching device searches a corresponding image from images taken within the shooting period inputted by the shooting period inputting device.

According to the sixteenth aspect, an image is added with information on the shooting date and time and stored in storage and an image can be designated by a period of the shooting date and time and printing.

To achieve the abovementioned intention, the seventeenth aspect of the present invention provides the printing systems of the thirteenth to the sixteenth aspects, wherein the inputting device is a digital camera.

According to the seventeenth aspect, an inputting device comprises a digital camera. An image of an object to be printed is obtained by being taken by the digital camera.

To achieve the abovementioned intention, the eighteenth aspect of the present invention provides the printing systems of the thirteenth to the sixteenth aspects, wherein the inputting device is a scanner.

According to the eighteenth aspect, an inputting device comprises a scanner. An image of an object to be printed is obtained by reading a picture of the object by the scanner.

To achieve the abovementioned intention, the nineteenth aspect of the present invention provides the printing systems of the thirteenth to the sixteenth aspects, wherein the inputting device is a media reader.

According to the nineteenth aspect, an inputting device comprises a media reader. An image of an object to be printed is obtained by reading the image from a storage medium by the media reader.

To achieve the abovementioned intention, the twentieth aspect of the present invention provides the printing systems of the thirteenth to the nineteenth aspects, wherein an image printed by the printing device is stored in the storage.

According to the twentieth aspect, an image printed by a printing device is stored in storage and accumulated.

To achieve the abovementioned intention, the twenty-first aspect of the present invention provides a printing system for printing an image taken by digital camera, comprising storage for storing an image taken by digital camera, an image identifying information generating device for generating information for identifying an image stored in the storage, a print controlling device for causing a printer to print an image taken by the digital camera together with the information generated by the image identifying information generating device, an image identifying device for reading the information added to the print and identifying an image to be printed stored in the storage, and a reprint controlling device for reading an image identified by the image identifying device from the storage and causing a printer to reprint the image.

According to the twenty-first aspect, when an image is printed for the first time, the image taken by digital camera is stored in storage and the image is printed together with information for identifying the image stored in the storage. When the image is reprinted, information added to the print is read and the image to be printed stored in storage is identified, and the identified image is read out from the storage and printed. In this manner, an image to be reprinted can be easily identified and tasks in reprinting an image can be performed easily and smoothly.

To achieve the abovementioned intention, the twenty-second aspect of the present invention provides the printing system of the twenty-first aspect, further comprising a clocking device for clocking a storage period of an image stored in the storage, and an image deleting device for deleting an image whose storage period is over a certain period from the storage as an expired image.

According to the twenty-second aspect, when an image stored in storage is expired, the image is automatically deleted from the storage. In this manner, the present invention can prevent unnecessary image data from occupying a part of capacity of storage.

To achieve the abovementioned intention, the twenty-third aspect of the present invention provides the printing system of the twenty-second aspect, wherein information generated by the image identifying information generating device includes information on expiration of an image, and wherein the system further comprises a determination device for reading information added to a print and determining whether the image to be printed is expired or not, and a noticing device for noticing a user that the image is expired when the image is determined as expired by the determination device.

According to the twenty-third aspect, information added to a print includes information on expiration of the image, and when the image is expired, the system notices the user of that. In this manner, a user can easily determine whether an image to be printed is expired or not.

To achieve the abovementioned intention, the twenty-fourth aspect of the present invention provides the printing system of the twenty-first to the twenty-third aspects, further comprising an inputting device for inputting the size and the number of print, wherein the print controlling device and the reprint controlling device cause a printer to print an image in the size and the number inputted by the inputting device.

According to the twenty-fourth aspect, the size and number of an image to be printed can be designated for printing the image. In this manner, the prints can be easily obtained in the necessary size and the necessary number.

With a printing method and a printing system according to the present invention, a once printed image can be easily reprinted.

### BRIEF DESCRIPTION OF THE DRAWINGS

FIG. 1 is a system architecture diagram showing an embodiment of a printing system according to the present invention;

FIG. 2 is a block diagram showing an electronic configuration of a digital camera;

FIG. 3 is a block diagram showing an electronic configuration of a print server;

FIG. 4 is a flowchart for showing a flow of creating a photo-print for certificate for printing the image for the first time;

FIGS. 5A to 5C are plane views showing examples of a photo-print for certificate;

FIG. 6 is a flowchart for showing a flow of creating a photo-print for certificate for reprinting the image;

FIG. 7 is a flowchart for showing a procedure of deleting an expired image file at the print server;

FIG. 8 is a system architecture diagram showing the second embodiment of a printing system according to the present invention;

FIG. 9 is a flowchart for showing a flow of creating a photo-print for certificate for printing the image for the first time;

FIG. 10 is a flowchart for showing a flow of creating a photo-print for certificate for reprinting the image;

FIGS. 11A to 11C are diagrams showing an exemplary display of a touch panel;

FIG. 12 is a diagram showing an exemplary display of a touch panel; and

FIG. 13 is a diagram showing exemplary displays of a touch panel.

### DETAILED DESCRIPTION OF THE PREFERRED EMBODIMENTS

The preferred embodiments for implementing a printing method and a printing system according to the present invention will be described with reference to the attached drawings.

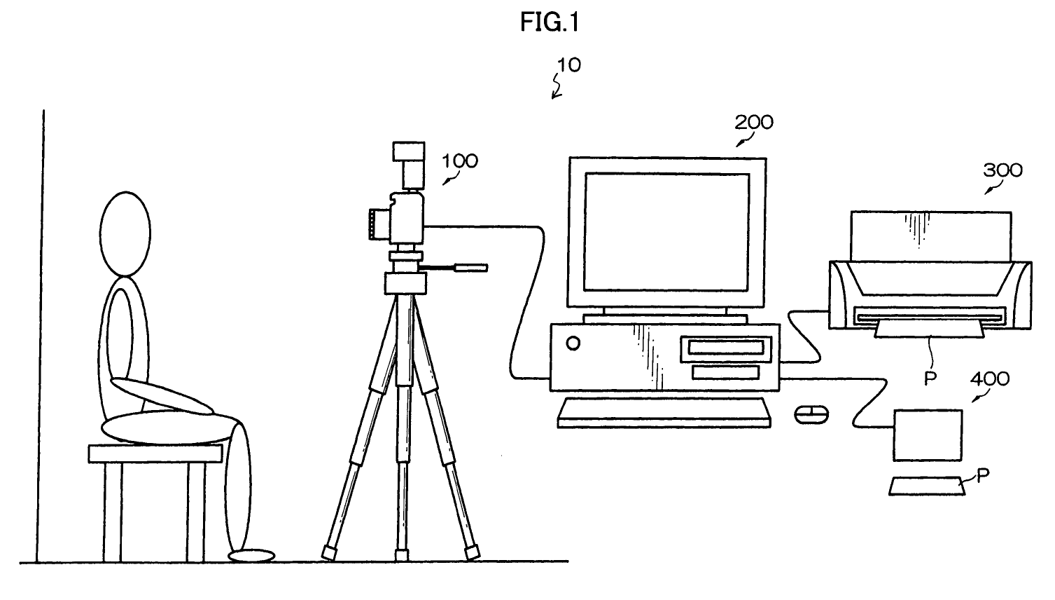

FIG. 1 is a system architecture diagram showing the first embodiment of a printing system according to the present invention. A printing system 10 of the embodiment is adapted as a system for taking a picture for certificate and printing the picture. The printing system 10 includes a digital camera 100 for taking a picture of an object, a print server 200 for receiving image data sent from the digital camera 100 and saving the image data, generating print data, a printer 300 for printing an image in response to a printing request from the print server 200, and a barcode reader 400.

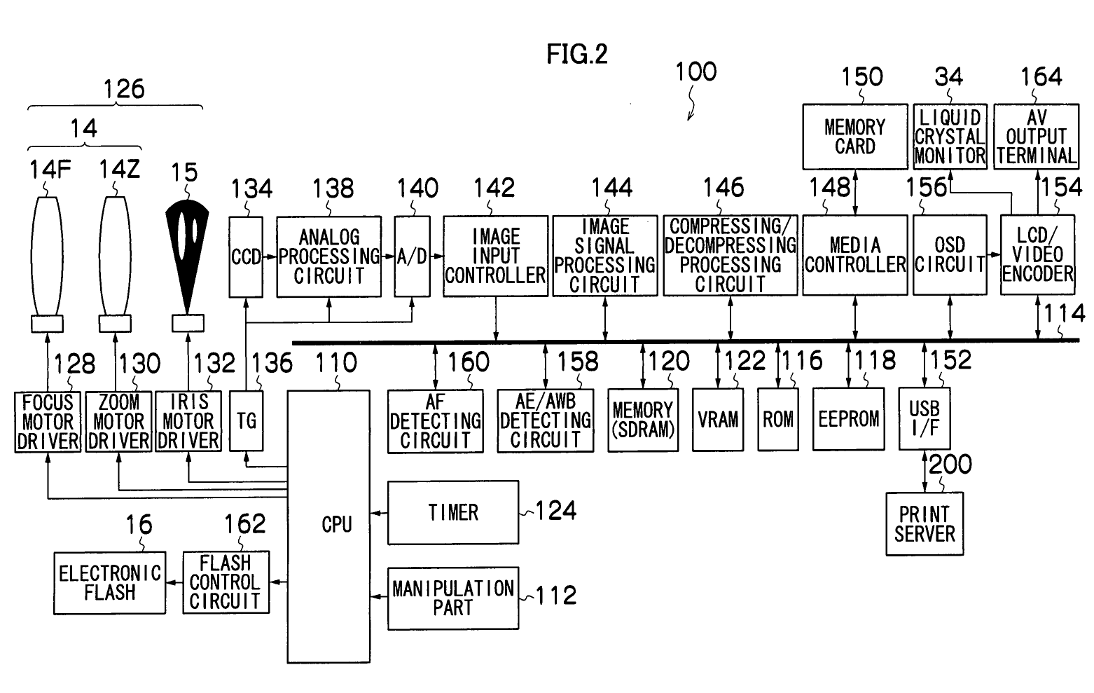

First, a configuration of the digital camera 100 will be described. FIG. 2 is a block diagram showing an electronic configuration of the digital camera 100. As shown in FIG. 2, the digital camera 100 includes a CPU 110, a manipulation part 112, a bus 114, ROM 116, EEPROM 118, memory (SDRAM) 120, VRAM 122, a timer 124, an optical unit 126, a focus motor driver 128, a zoom motor driver 130, an iris motor driver 132, an imaging element 134, a timing generator (TG) 136, an analogue processing circuit 138, an A/D converter 140, an image input controller 142, an image signal processing circuit 144, a compression/decompression processing circuit 146, an media controller 148, a memory card 150, a USB interface 152, a LCD/video encoder 154, an OSD circuit 156, an AE/AWB detecting circuit 158, an AF detecting circuit 160, a flash control circuit 162.

The CPU 110 functions as a controlling part for controlling over operations of the entire digital camera 100. The CPU 110 also functions as a calculation device for performing various calculations. The CPU 110 controls each circuit according to a predetermined controlling program based on what inputted from the manipulation part 112.

The ROM 116 connected with the CPU 110 via the bus 114 stores controlling programs performed by the CPU 110 and various types of data necessary for controlling. The EEPROM 118 stores various types of setting information relating to operations of the digital camera 100, such as user-set-information.

The memory (SDRAM) 120 is used as a working area for calculation of the CPU 110 and as a temporally storage of image data. The VRAM 122 is used as a temporally storage specific to image data to be displayed.

The timer 124 clocks the current date and time and outputs the clocked current date and time to the CPU 110. The CPU 110 obtains information on shooting date and time or the like based on information on the current date and time clocked by the timer 124.

The optical unit 126 includes a picture-taking lens 14 and an iris 15. The picture-taking lens 14 includes a focus lens 14F, which is driven by a focus motor (not shown) in moving to and fro along an optical axis, and a zoom lens 14Z, which is driven by a zoom motor (not shown) in moving to and fro along an optical axis. The CPU 110 controls a focus of the picture-taking lens 14 by controlling the driving of the focus motor via the focus motor driver 128. The CPU 110 also controls a zoom of the picture-taking lens 14 by controlling the driving of the zoom motor via the zoom motor driver 130. The iris 15 includes a turret iris. The iris 15 is driven by an iris motor (not shown) in changing the diameter of the aperture (aperture value). The CPU 110 controls the iris 15 by controlling the driving of the iris motor via the iris motor driver 132.

The imaging element 134 includes a color CCD attached with color filters of R, G and B. The light coming on an acceptance surface of the imaging element 134 via the optical unit 126 is converted into signal charge in the amount appropriate for the amount of incoming light by multiple photo-diodes arranged on the acceptance surface.

The timing generator (TG) 136 mainly generates a timing signal for mainly driving the imaging element 134 according to an instruction from the CPU 110. The imaging element 134 outputs the signal charge accumulated in each photo-diode as a voltage signal (image signal) according to the timing signal applied by the timing generator 136.

The analog processing circuit 138 performs correlated-double-sampling on the image signal serially outputted from the imaging element 134 and amplifies the signal.

The A/D converter 140 converts each of analog image signals of R, G and B outputted from the analog processing circuit 138 into a 12-bit digital image signal.

The image input controller 142 includes a line buffer for a predetermined capacity. The image input controller 142 accumulates image signals for a single image outputted from the A/D converter 140 and stores it in the memory 120.

The image signal processing circuit 144 includes a synchronizing circuit (a processing circuit for synchronously converting color signals by interpolating a spatial gap between the color signals due to an arrangement of color filters on a single panel CCD), a white balance correction circuit, a gamma correction circuit, an outline correction circuit and brightness/color-difference signal generation circuit. The image signal processing circuit 144 performs necessary signal processing on the digital image signals inputted according to an instruction from the CPU 110 and generates image data.

The compressing/decompressing processing circuit 146 compresses the inputted image data and generates compressed image data in a predetermined format according to an instruction from the CPU 110. The compressing/decompressing processing circuit 146 also decompresses the inputted compressed image data and generates non-compressed digital image data.

The media controller 148 controls reading/writing of data from/to the memory card 150 inserted into a card slot, according to an instruction from the CPU 110.

The USB interface 152 communicates with the print server 200 via a USB cable in complying with the USB standard, according to an instruction from the CPU 110.

The LCD/video encoder 154 generates signals for displaying an image shown by image data on a liquid crystal monitor 34 and outputs the signals to the liquid crystal monitor 34, according to an instruction from the CPU 110. The LCD/video encoder 154 also generates signals for displaying an image indicated by image data on a TV (for example, an NTSC signal, a PAL signal, or an SCAM signal) and outputs the signals to an AV output terminal 164.

The OSD (On Screen Display) circuit 156 outputs signals indicating a character or a graphic to be displayed on a screen to the LCD/video encoder 154, according to an instruction from the CPU 110.

The AE/AWB detecting circuit 158 calculates the physical quantities necessary for controlling AE and controlling AWB from the inputted image signals, according to an instruction from the CPU 110. For example, the AE/AWB detecting circuit 158 calculates an accumulated value of R, G and B as the physical quantity necessary for controlling AE by dividing a screen into multiple areas (for example 16 x 16) and accumulating image signals of R, G and B for each of the divided areas. The CPU 110 detects brightness of the object (object brightness) based on the accumulated value obtained from the AE/AWB detecting circuit 158, calculates an exposure value appropriate for the shooting (shooting EV value) and determines the aperture value and the shutter speed based on the calculated shooting EV value and a predetermined program diagram. The AE/AWB detecting circuit 158 also calculates an average accumulated value for each color of image signals of R, G and B as the physical quantity necessary for controlling AWB by dividing a screen into multiple areas (for example 16×16) and accumulating image signals of R, G and B for each of the divided areas. The CPU 110 calculates the ratios of R/G and B/G for each of the divided areas based on the obtained accumulated values for R, B and G, and determines the type of light source based on distribution and the like of the calculated values of R/G and B/G in color spaces of R/G and B/G. Then, the CPU 110 determines a gain value of a white balance adjustment circuit against R, G and B values (white balance correction value) so that a value of each ratio is around 1 (i.e., the accumulated ratio of R, G and B in a single screen is R:G:B≠1:1:1), according to the white balance adjustment value appropriate for the determined type of light source.

The AF detecting circuit 160 calculates the physical quantity necessary for controlling AF based on the inputted image signal, according to an instruction from the CPU 110. The digital camera 100 of the embodiment is assumed to perform AF controlling based on a contrast of an image. Therefore, the AF detecting circuit 160 calculates a focus evaluation value indicating the sharpness of the image in a predetermined ranging area based on the inputted image signal. The CPU 110 controls the movement of the focus lens 14F by controlling the driving of the focus motor driver 128 so that the focus evaluation value calculated by the AF detecting circuit 160 is the maximum (i.e., moves the focus lens 14F to the point where the focus evaluation value is maximum).

The flash control circuit 162 controls light emission from the electronic flash by controlling an electronic flash 16, according to an instruction from the CPU 110.

Now, basic operations in shooting an image by the digital camera 100 with the abovementioned configuration will be described.

A user can operate AE, AF and AWB of the digital camera 100 by pressing the shutter button on the manipulation part 112 by half, and take a picture and record the image by pressing the shutter button to the end.

When the shutter button is pressed by half, an S1ON signal is inputted from the manipulation part 112 to the CPU 110. In response to the S1ON signal,the CPU 110 performs the processing of AE, AF and AWB.

First, in response to the S1ON signal, an image signal outputted from the imaging element 134 is captured in the image input controller 142 via the analogue processing circuit 138 and the A/D converter 140 and stored in the memory 120. The image signal stored in the memory 120 is applied to the AE/AWB detecting circuit 158 and the AF detecting circuit 160.

As mentioned above, the AE/AWB detecting circuit 158 calculates the physical quantities necessary for controlling AE and controlling AWB based on the inputted image signal under the control of the CPU 110 and outputs the physical quantities to the CPU 110. The CPU 110 determines the aperture value and the shutter speed based on what outputted from the AE/AWB detecting circuit 158 and determines the white balance correction value.

The AF detecting circuit 160 calculates a focus evaluation value indicating the sharpness of the image in a predetermined ranging area based on the inputted image signal and outputs the value to the CPU 110, under the control of the CPU 110. The CPU 110 controls the movement of the focus lens 14F by controlling the driving of the focus motor driver 128 so that the focus evaluation value calculated by the AF detecting circuit 160 is the maximum.

As such, when a shutter button 26 is pressed by half, the object is focused. The photographer adjusts the composition by manipulating the zoom button 36 as required and presses the shutter button to the end. When the shutter button 26 is pressed to the end, an S2ON signal is inputted from the manipulation part 112 into the CPU 110. In response to the S2ON signal, the CPU 110 performs recording of the image.

First, the CPU 110 exposes the imaging element 134 to light with the abovementioned aperture value and shutter speed obtained by AE processing and captures an image signal for recording. The image signal outputted from the imaging element 134 is captured in the image input controller 142 via the analogue processing circuit 138 and the A/D converter 140 and stored in the memory 120. The image signal stored in the memory 120 is applied to the image signal processing circuit 144, converted into image data (YC data) consisting of brightness data and color-difference data, and stored in the memory 120 under the control of the CPU 110. The image data stored in the memory 120 is applied to the compressing/decompressing processing circuit 146 and compressed according to a predetermined compression format (for example, JPEG), then stored in the memory 120.

The CPU 110 generates an image file in a predetermined format (for example, Exif) by adding additional information including the shooting date and time, the aperture value and the shutter speed to the compressed image data stored in the memory 120. Then, the CPU 110 stores the generated image file in the memory card 150 via the media controller 148 and also sends the image file to the print server 200 via the USB interface 152.

A picture is taken and recorded in the abovementioned series of operations. The digital camera 100 is adapted to replay the image recorded in the memory card 150 when the mode of the camera is set to the replay mode. The digital camera 100 is adapted to display the taken picture on the liquid crystal monitor 34 or on an external monitor connected via the AV output terminal 164.

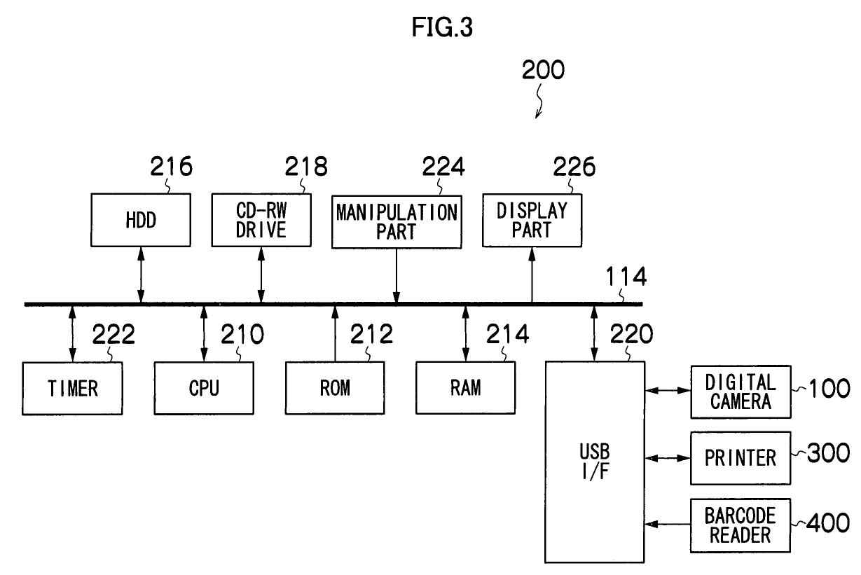

Now, a configuration of the print server 200 will be described. FIG. 3 is a block diagram showing an electronic configuration of a print server. The print server 200 is a typical computer including a CPU 210, ROM 212, RAM 214, a hard disk (HDD) 216, a CD-RW drive 218, a USB interface 220, a timer 222, an operating part 224 and a display part 226.

The CPU 210 functions as a controlling part for controlling over operations of the entire print server. In response to what inputted from the manipulation part 224, the CPU 210 performs communication control, recording/deleting control of image data, generation of image identifying data, encoding of image identifying data, searching of image data, generation of print data, control of printing and displaying control to the display part 226, according to a predetermined controlling program by using the RAM 214 as a working area.

The hard disk (storage) 216 is used for storing an operating system (OS) and various application programs as well as for storing image data.

The CD-RW drive 218 reads and writes data to and from the inserted CD-RW under the control of the CPU 210 (in case of CD-ROM, only reads data from there).

The USB interface 220 communicates with the digital camera 100, the printer 300 and the barcode reader 400 connected via a USB cable complying with the USB standard, according to an instruction from the CPU 210.

The timer 222 clocks the current date and time according to a clocking request from the CPU 210 and gives information on the clocked current time to the CPU 210.

The manipulation part 224 includes a keyboard, a mouse or the like. The display part 226 includes a liquid crystal display.

The printer 300 prints and outputs the image on a paper medium or the other recording sheet based on print data sent from the print server 200. The printing mode is not limited to particular modes and the modes including TA mode, inkjet mode, and laser mode can be used. In this example, an image is assumed to be printed in the TA mode.

The barcode reader 400 reads a two-dimensional barcode added to a print P and sends the read information to the print server 200, as described later. The print server 200 identifies image data stored in the hard disk 216 based on the information sent from the barcode reader 400. The print server 200 also determines expiration of the image.

Now, a flow of creating a picture for certificate in the printing system of the embodiment with the abovementioned configuration will be described.

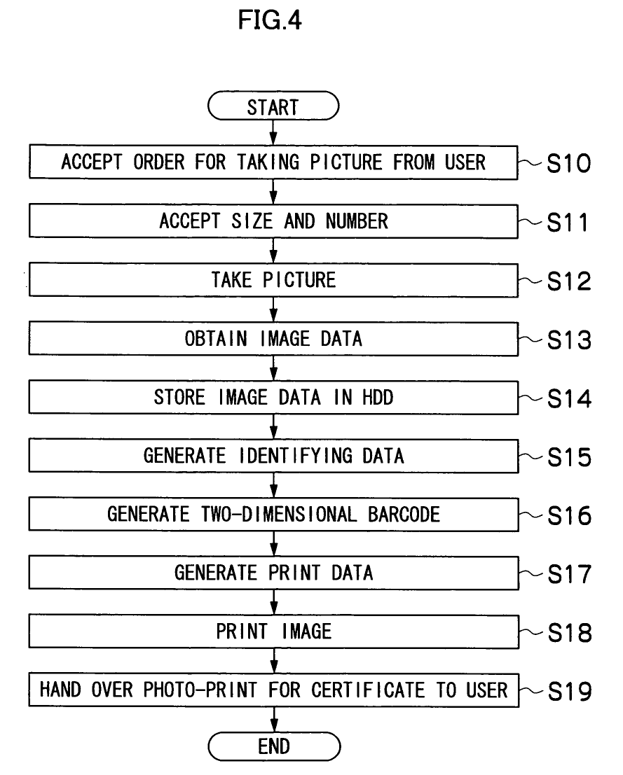

First, a flow of creating a photo-print for certificate for the first time, i.e., creating a new photo-print for certificate will be described with reference to a flowchart shown in FIG. 4.

First, a user goes to a photo-studio and asks to take a picture for certificate of himself (step S10). In response to the request, the photo-studio accepts the size and the number of print from the user (step S11). Then, the photographer takes a picture of the user with the digital camera 100 in accordance with the accepted conditions (step S12).

The image file containing the taken image is recorded in the memory card 150 of the digital camera 100. An operator manipulates to send the image file to the print server 200. The print server 200 receives the image file sent from the digital camera 100 (step S13) and stores the received image file in the hard disk 216 (step S14).

At this moment, the print server 200 gives a predetermined file name to the image file received from the digital camera 100 and stores the name in a predetermined storage. Then, the print server 200 generates image identifying data for identifying the image file stored in the hard disk 216 (step S15), and encodes the image identifying data into a two-dimensional barcode (step S16). The image identifying data includes information on expiration of the image as well as information indicating where the image is stored. The expiration is set a predetermined period after the shooting date. In this example, the expiration is assumed to be set six months after the shooting date. If the shooting date is Jun. 25, 2004, the expiration is Dec. 25, 2004.

Then, the print server 200 generates print data for printing the image by the printer 300 according to manipulation of the operator (step S17).

First, the operator inputs size information and number information of the picture for certificate asked by the user from the manipulation part 224. The print server 200 generates print data for printing the image by the printer 300 according to the inputted size information and number information.

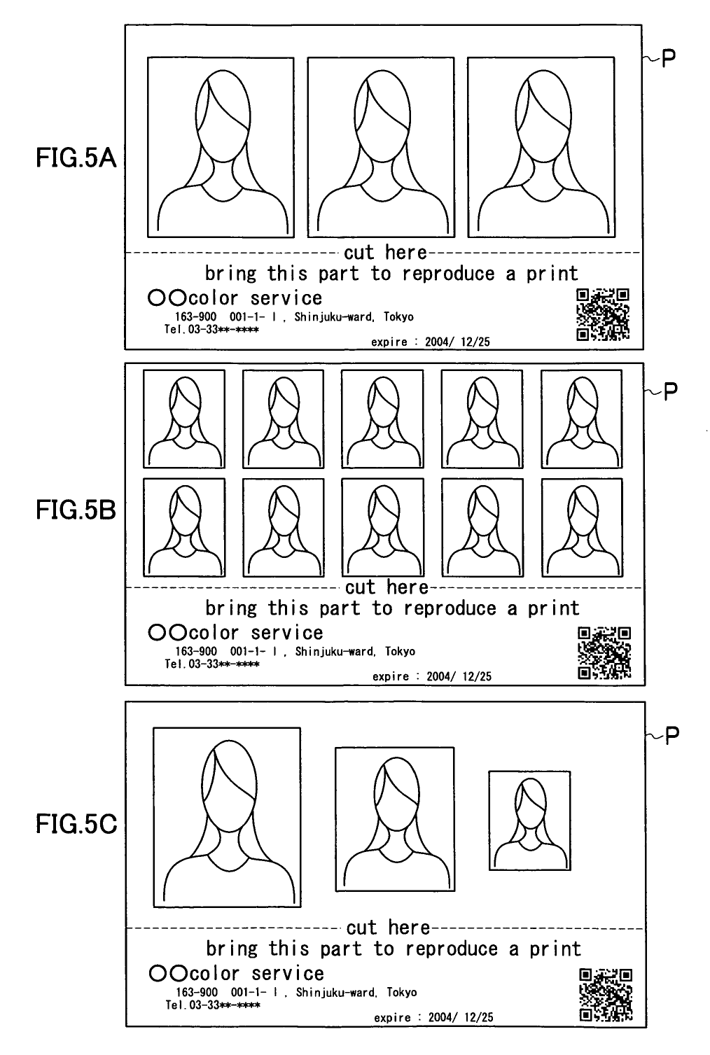

FIGS. 5A to 5C are plane views showing examples of a photo-print for certificate. As shown in the figures, a photo-print for certificate P includes an image printing part and a two-dimensional barcode printing part. In the image printing part, pictures for certificate are printed in the designated size and number in a predetermined layout. In the two-dimensional barcode printing part, the two-dimensional barcode of the image identifying data, shop information, expiration and the like are printed. The print server 200 sets a layout of images for the pictures for certificate to be printed in the image printing part based on the size information and number information inputted from the manipulation part 224 and generates print data for obtaining the photo-print for certificate P as shown in FIGS. 5A to 5C. Then, the print server 200 outputs the generated print data to the printer 300.

The printer 300 generates the photo-print for certificate P by printing the image on a sheet of photographic paper based on the print data outputted from the print server 200 (step S 18). The operator hands over the photo-print for certificate P outputted from the printer 300 to the user (step S19).

The processing of first printing is performed through the series of steps. The user cuts each picture for certificate from the received photo-print for certificate P for use.

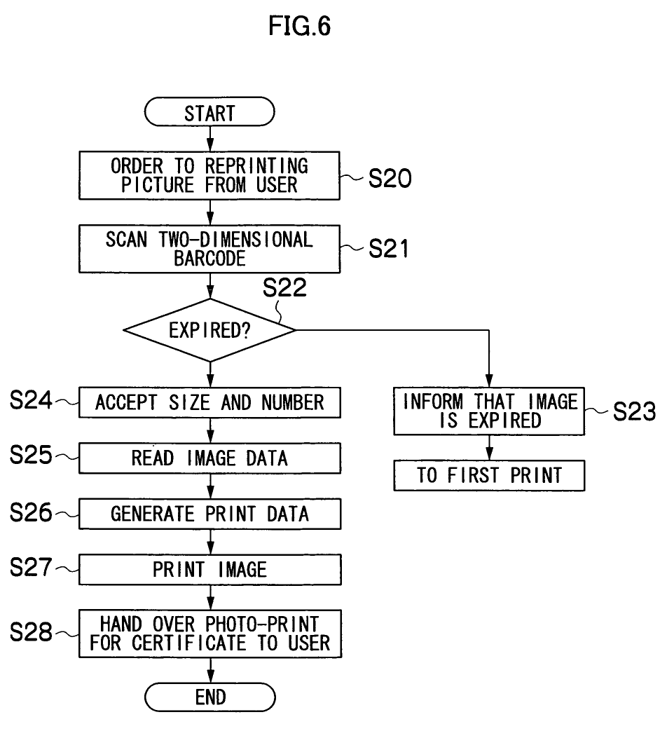

Now, a flow of processing in reprinting, i.e., reproducing a picture will be described with reference to a flowchart shown in FIG. 6.

First, a user brings the two-dimensional barcode added to the photo-print for certificate P, which the user received at the first printing, and asks the photo-studio to reprint the picture. The photo-studio responds to the user's order for reprinting the picture (step S20) and receives the two-dimensional barcode from the user. An operator scans the received two-dimensional barcode with the barcode reader 400 (step S21).

The barcode reader 400 decodes the scanned two-dimensional barcode and sends the information recorded there, i.e., image identifying data and expiration information to the print server 200.

The print server 200 receives the image identifying data and expiration information sent from the barcode reader 400, and determines whether the image requested for reprinting is expired or not based on the received expiration information and the current date and time information clocked by the timer 222 (step S22).

If it is determined that the image is expired, the print server 200 displays a message that the image is expired on the display part 226. The operator at the photo-studio tells the user that the requested image is expired according to the displayed message (step S23). In response to this, the user has himself photographed again, i.e., performs processing of the first printing.

If it is determined that the image is not expired, the print server 200 displays a message that the image is not expired on the display part 226. The operator at the photo-studio accepts the size and the number of the image to be reprinted from the user according to the displayed message (step S24). Then, the operator inputs the accepted size and number from the manipulation part 224 of the print server 200.

The print server 200 identifies the corresponding image file stored in the hard disk 216 based on the image identifying data received from the barcode reader 400, and reads the identified image file from the hard disk 216 (step S25). Then, the print server 200 generates print data for reprinting the image based on the read out image file and the inputted size information and number information (step S26). The print data is generated so that an image printing part and a two-dimensional barcode printing part are printed on a sheet of photographic paper as they are printed for the first time (see FIGS. 5A to 5C).

The print server 200 outputs the generated print data to the printer 300. The printer 300 prints the image on a sheet of photographic paper based on the print data outputted from the print server 200 (step S27). The operator hands over the photo-print for certificate P outputted from the printer 300 to the user (step S28).

The processing of reprinting is performed through the series of steps. The user cuts each picture for certificate from the received photo-print for certificate P for use.

The printing system of the embodiment identifies an image to be reprinted based on the two-dimensional barcode. In this manner, an image file can be easily identified and reprinting tasks can be performed easily and smoothly.

Moreover, as the printing system reprints an image after checking the image for expiration, it can provide an authorized photo-print for certificate for the user.

An image file of an expired image is automatically deleted from the hard disk 216 when it is expired, as storing of the image file does nothing but just occupies a part of free space of the hard disk 216.

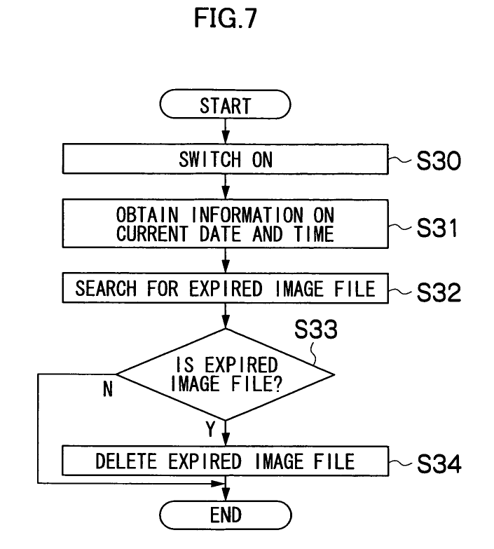

FIG. 7 is a flowchart for showing a procedure of deleting an expired image file at the print server 200.

First, the print server 200 is switched on (step S30). The CPU 210 of the print server 200 obtains information on the current date and time from the timer 222 (step S31). Then, the CPU 210 searches the hard disk 216 for an expired image file based on the obtained current date and time (step S32). That is to say, the CPU 210 reads information on shooting date and time added to respective image files stored in the hard disk 216, determines whether each of their shooting date and time is older than the expiration period of six months or not to search an expired image file.

The CPU 210 determines the presence of expired image file (step S33). If the CPU 210 determines that there is an expired image file, it deletes the image file from the hard disk 216 (step S34).

In this manner, an expired image file is automatically deleted. As such, the present invention can prevent unnecessary image file from being accumulated and occupying a part of capacity in the hard disk 216.

In this embodiment, expired image files are searched when the print server 200 is switched on, though, they are not limited to be searched at this time. They can be searched when the date changes or when an operator instructs to do so.

In the abovementioned embodiment, an image file is stored in the hard disk 216 in the print server 200, though; an image file is not limited to be stored here. The print server 200 may be connected with a network so that an image file can be stored in a server set on the network.

In the abovementioned embodiment, the digital camera 100, the print server 200, the printer 300 and the barcode reader 400 are shown separately, though, those multiple appliances can be integrated together. The print server 200, the printer 300 and the barcode reader 400 may be integrated together or the print server 200 and the barcode reader 400 may be integrated. All the appliances can be integrated to make a shooting box.

In the abovementioned embodiment, between a digital camera and a print server, between a print server and a printer, between a print server and a barcode reader are connected by USB cable, respectively, to communicate each other, though, the components are not limited to communicate in this manner and they can be connected and communicate each other in the other manners. The appliances may wirelessly communicate each other for sending and receiving data. An image file shot by the digital camera 100 may be captured into the print server 200 via the memory card 150.

In the abovementioned embodiment, a two-dimensional barcode, which is encoded image identifying data or the like, is added to a photo-print for certificate, though, the barcode may be handed over to a user separately from the photo-print.

The two-dimensional barcode may be sent to a cellular phone of a user in a form of electronic mail. In such a case, the user asks to reprint an image by showing the two-dimensional barcode on the display of the cellular phone. In response to this, an operator of the photo-studio scans the two-dimensional barcode shown on the display of the cellular phone with the barcode reader 400 and reads image identifying data from there. Alternatively, a user may ask to reprint an image by sending electronic-mail including designation of the size and the number to print the image and the two-dimensional barcode to the photo-studio. In this manner, a user can make an order for reprinting an image before visiting the photo-studio so as to receive reprinted photo-prints for certificate at the photo-studio without waiting.

In the embodiment, the two-dimensional barcode added to the photo-print for certificate P is read by the barcode reader 400 set at the photo-studio, though, the barcode can be read by the user's cellular phone, if the cellular phone has a function of reading a two-dimensional barcode. In such a case, the user sends the read information to the print server 200 together with information on the ordering size and number via a telephone line. In this manner, a user also can make an order for reprinting an image before visiting the photo-studio so as to receive reprinted photo-prints for certificate at the photo-studio without waiting.

In the embodiment, image identifying data or the like is encoded in the form of two-dimensional barcode for management, though, the data can be encoded in the form of one-dimensional barcode for management. Alternatively, the data can be managed by numbers.

In the embodiment, image identifying data and expiration information is encoded in the form of two-dimensional barcode, though, only image identifying data may be encoded in the form of two-dimensional barcode. In such a case, the image is checked for expiration by using information on shooting date and time added to an image file identified from the two-dimensional barcode. In other words, if a period passed from the shooting date and time added to the image file identified from the two-dimensional barcode is over the preset expiration period (for example, six months), the image is determined as expired. Similarly, in the case that a user brings an image file to be printed as a photo-print for certificate to the photo-studio, the image is checked for expiration based on information on the shooting date and time added to the image file.

Now, the second embodiment of a printing system according to the present invention will be described.

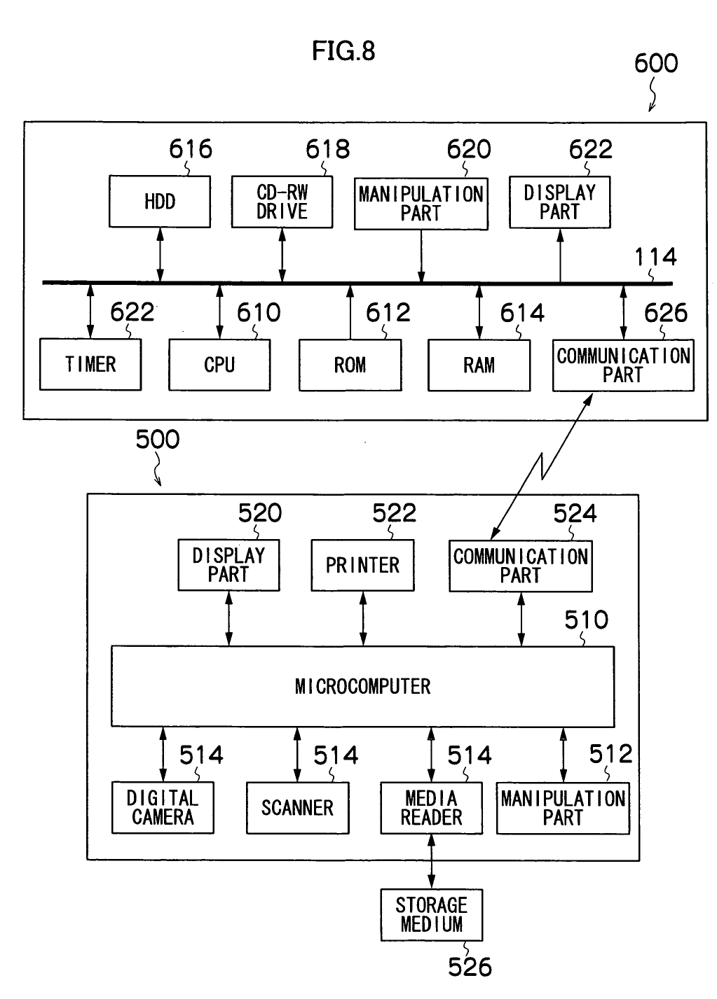

FIG. 8 is a system architecture diagram showing the second embodiment of a printing system according to the present invention.

As shown in the figure, the printing system of the embodiment includes a reception terminal 500 and a management server 600 and is adapted as a system for taking a picture for certificate and printing the image as that of the first embodiment does.

The reception terminal 500 takes a picture for certificate and prints the image. The reception terminal 500 mainly includes a micro-computer 510, a manipulation part 512, a digital camera 514, a scanner 516, a media reader 518, a display part 520, a printer 522 and a communication part 524.

The microcomputer 510 functions as a controlling part for controlling over operations of the entire reception terminal. In response to what inputted from the manipulation part 512, the microcomputer 510 performs control of the digital camera 514, the scanner 516 and the media reader 518, input control of image data from the appliances, generation of print data, control of communication with a management server, print control of the printer 522, display control of the display part 520 and the like according to a predetermined controlling program.

The manipulation part 512 includes a touch panel, for example, and set on the surface of the display part 520.

The digital camera 514 shoots an image and outputs image data obtained by the shooting to the microcomputer 510, under the control of the microcomputer 510.

The scanner 516 reads a print of photograph or the like placed on a predetermined scanning table and outputs what is read as image data to the microcomputer 510, under the control of the microcomputer 510.

The media reader 518 reads image data from a storage medium such as a memory card and outputs the data to the microcomputer 510, under the control of the microcomputer 510.

The display part 520 includes a liquid crystal display, for example, and displays predetermined information under the control of the microcomputer 510.

The printer 522 prints and outputs an image on a paper medium or the other recording sheet based on predetermined print data under the control of the microcomputer 510. The printing mode is not limited to particular modes and the modes including TA mode, inkjet mode, and laser mode can be used. In this example, an image is assumed to be printed in the TA mode.

The communication part 524 communicates with the management server 600 for sending and receiving image data and the other information to and from there under the control of the microcomputer 510.

The management server 600 manages image data that printed once. The management server 600 is a typical computer including a CPU 610, ROM 612, RAM 614, a hard disk (HDD) 616, a CD-ROM drive 618, a manipulation part 620, a display part 622, a timer 624 and a communication part 626.

The CPU 610 functions as a controlling part for controlling over operations of the entire management server. The CPU 610 performs communication control, recording/deleting control of image data, searching of image data and control of displaying to the display part 622 according to a predetermined controlling program by using the RAM 614 as a working area based on what inputted from the manipulation part 620.

The hard disk (storage) 616 is used for storing an OS and various application programs as well as for storing image data.

The CD-ROM drive 618 reads data from an inserted CD-ROM under the control of the CPU 610.

The manipulation part 620 includes a keyboard, a mouse or the like. The display part 622 includes a liquid crystal display.

The timer 624 clocks the current date and time according to a clocking request from the CPU 610 and gives information on the clocked current time to the CPU 610.

The communication part 626 communicates with the reception terminal 500 for sending and receiving image data and the other information to and from there under the control of the CPU 610.

Now, a flow of creating a picture for certificate in the printing system of the second embodiment with the abovementioned configuration will be described.

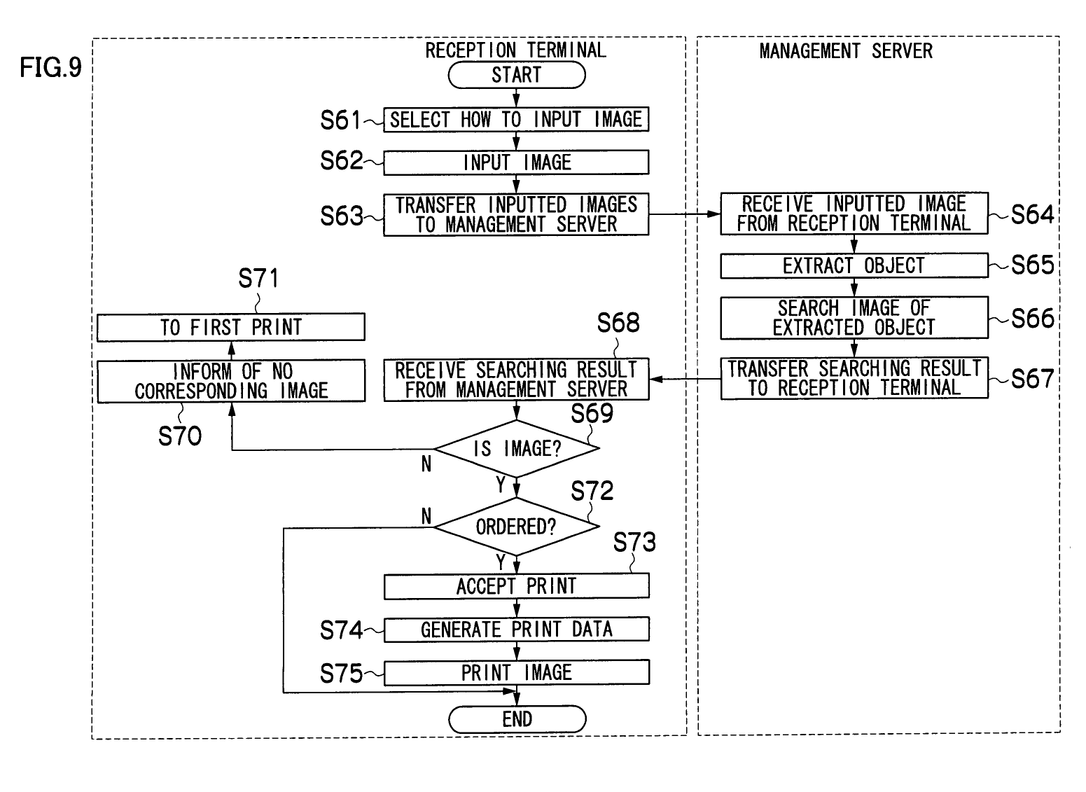

First, a flow of creating a photo-print for certificate for the first time, i.e., creating a first photo-print for certificate will be described with reference to a flowchart shown in FIG. 9.

The picture for certificate is taken and printed at the reception terminal 500. First, the reception terminal 500 accepts the size and the number to be shot from a user (step S5 1). After the reception, the terminal takes a picture of the user with the digital camera 514 (step S52).

A microcomputer of the reception terminal 500 obtains image data shot by the digital camera 512 (step S53), and creates print data from the obtained image data in accordance with the accepted order (step S54). Then, the microcomputer outputs the created print data to the printer 522 to make the printer 522 print the image in accordance with the accepted order (step S55). The user receives the generated print.

After the printing, the microcomputer 510 of the reception terminal 500 transfers the printed image data to the management server 600 (step S56).

The management server 600 receives the image data transferred from the reception terminal 500 (step S57), and stores the received image data in the hard disk 616 (step S58).

The processing of first printing is performed through the series of steps.

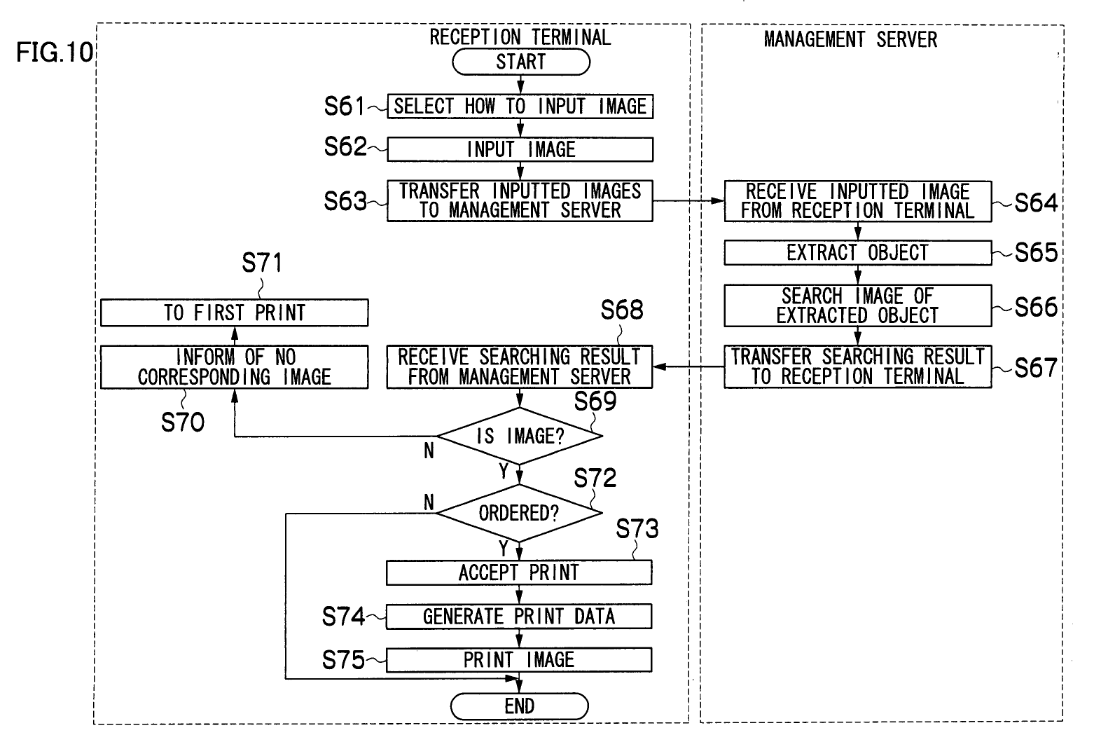

Now, a flow of processing in reprinting, i.e., reproducing a picture will be described with reference to a flowchart shown in FIG. 10.

When an image is reprinted, an image of the user's face is inputted in the reception terminal 500, a group of images stored in the hard disk 616 of the management server 600 is searched for an image of the user, and the searched image is printed.

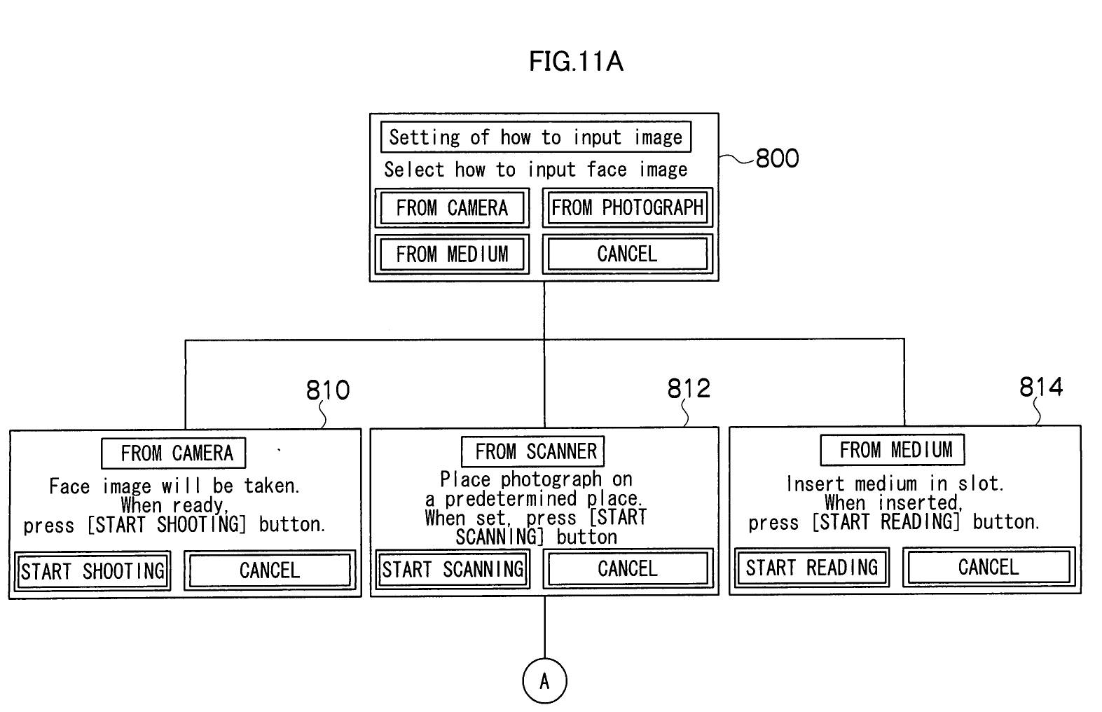

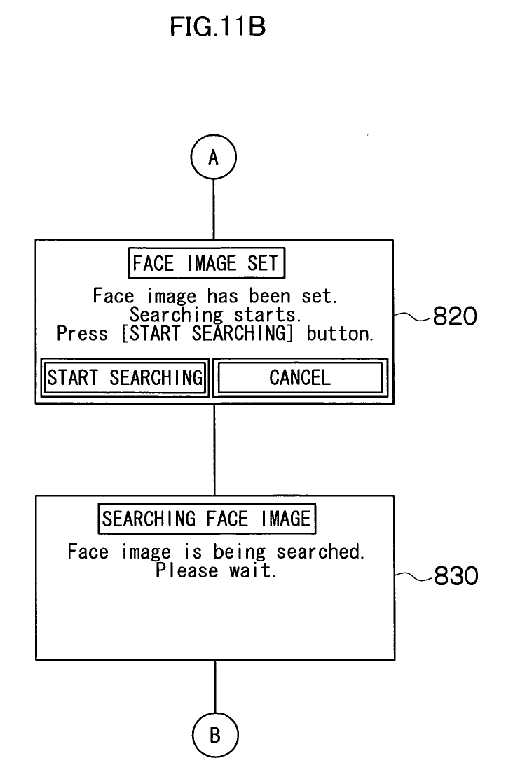

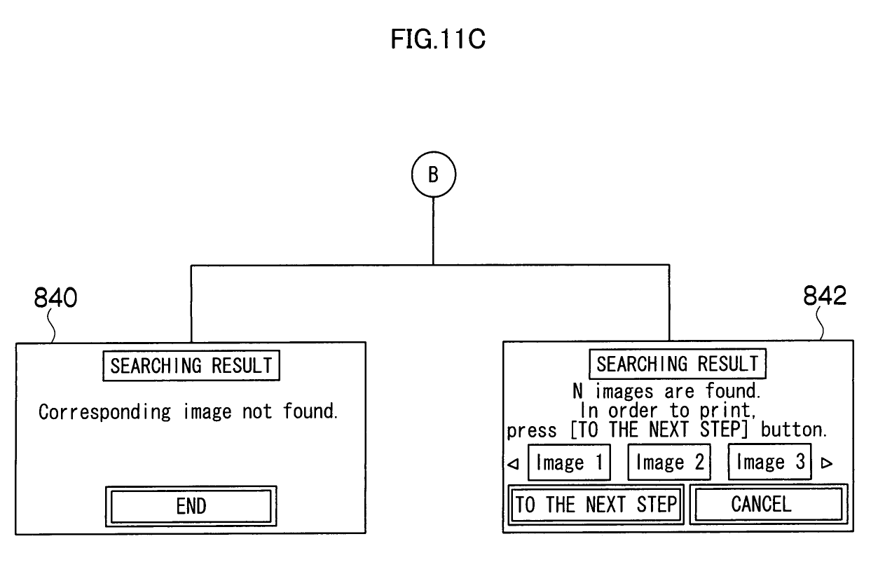

First, the user selects how to input a face image at the reception terminal 500 (step S61). The user selects a desired inputting method form the prepared methods; (1) a method for inputting the user's image by directly taking a picture of the user with the digital camera 514, (2) a method for inputting the user's image by reading a picture of the user's face images brought by the user with the scanner 516, and (3) a method for inputting the user's image by reading an images stored in a medium 526 brought by the user with the media reader 518. The user selects a method on a touch panel (manipulation part 512). Numeral 800 in FIG. 11A shows an exemplary display of a touch panel (an exemplary display on a display part 520 provided with a touch panel). The user selects a method for inputting the image by pressing a button indicating the desired inputting method among the buttons indicating inputting methods displayed on the touch panel.

When a method for inputting a face image is selected, the microcomputer 510 of the reception terminal 500 performs processes according to the selected inputting method and inputs the image (step S62).

When a method for inputting an image from the digital camera 514 is selected, the microcomputer 510 of the reception terminal 500 displays a manipulation guide on the touch panel, controls the digital camera 514 according to what inputted from the touch panel, takes a picture of the user, and obtains the image. Numeral 810 in FIG. 11A shows an exemplary display of a touch panel when a face image is inputted from the digital camera 514.

When a method for inputting an image from the scanner 516 is selected, the microcomputer 510 of the reception terminal 500 also displays a manipulation guide on the touch panel, controls the scanner 516 according to what inputted from the touch panel, captures an image from the picture, and obtains the image. Numeral 812 in FIG. 11A shows an exemplary display of a touch panel when an image is inputted from the scanner 516.

When a method for inputting an image from the medium 526, the microcomputer 510 of the reception terminal 500 also displays a manipulation guide on the touch panel, controls the media reader 518 according to what inputted from the touch panel, captures an image, and obtains the image. Numeral 814 in FIG. 11A shows an exemplary display of a touch panel when an image is inputted from the medium 526.

When an image is inputted by the selected method, the microcomputer 510 of the reception terminal 500 sends the inputted images to the management server 600 based on the manipulation from the touch panel (step S63). Numeral 820 in FIG. 11B shows an exemplary display of a touch panel at the end of setting.

The management serer 600 receives the image sent from the reception terminal 500 (step S64). When the CPU 610 of the management server 600 receives the image, it extracts a face area from the received image according to a predetermined image processing program (step S65). Then, the CPU 610 searches the images stored in the hard disk 616 for an image of the extracted face according to a predetermined searching program (step S66). Numeral 830 in FIG. 11B shows an exemplary display of a touch panel.

As a method for extracting a face area and a method for detecting an image of the face are well-known methods, specific descriptions of the processing will be omitted.

When the searching is over and an image is found, the CPU 610 of the management server 600 sends the searched image to the reception terminal 500. If no image is found, the CPU 610 sends information that no corresponding image is found to the reception terminal 500 (step S67). The reception terminal 500 receives the searching result sent from the management server 600 (step S68). Then, the reception terminal 500 determines the presence of the image based on the searched result (step S69).

If it is determined that there is no corresponding image, i.e., that no image is found as a result of the determination, the microcomputer 510 of the reception terminal 500 outputs a message that there is no corresponding image on the touch panel as shown in numeral 840 in FIG. 11C (step S70). The user reads the message and performs the first printing if needed (step S71).

If it is determined that there are a corresponding image, i.e., that a corresponding is found, the microcomputer 510 of the reception terminal 500 displays the found image on the touch panel as shown in numeral 842 in FIG. 11C.

Then, the microcomputer 510 of the reception terminal 500 determines the presence of an order for printing an image based on what inputted from the touch panel (step S72).

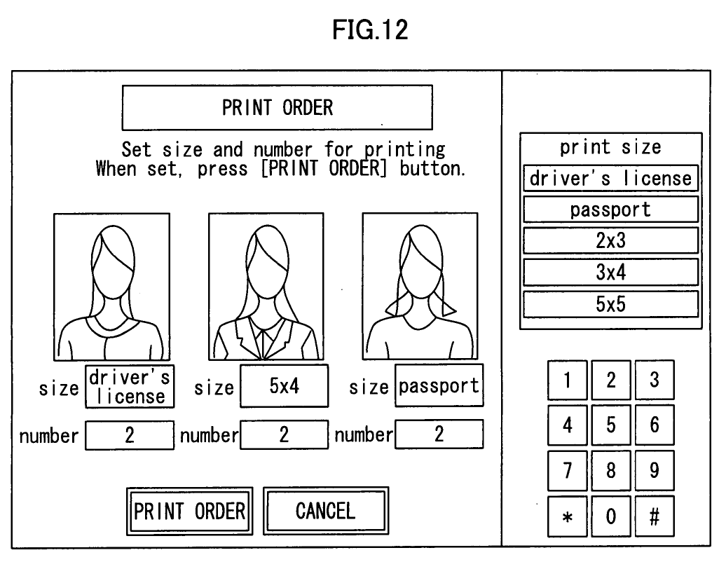

If it is determined that there is an order for printing an image, the microcomputer 510 of the reception terminal 500 displays a print reception screen on the touch panel and performs reception of the printing. That is to say, the microcomputer 510 accepts the input of the user's selected image, size and the number for printing (step S73). FIG. 12 shows an exemplary display of a print reception screen. The user inputs information required for ordering to print an image according to prompts displayed on the screen.

When the user orders to print an image and inputs an instruction to perform the printing from the touch panel, the microcomputer 510 of the reception terminal 500 generates print data based on the inputted information (step S74). Then, the microcomputer 510 outputs the generated print data to the printer 300 and causes the printer 522 to print the image. The generated print is discharged from a predetermined opening. The user receives the discharged print from the opening.

The processing of reprinting is performed through the series of steps.

As the printing system of the embodiment needs no information for identifying an image to be reprinted for reprinting the image, the user can easily reprint a desired image. If a user loses information for identifying an image to be reprinted or leaves the information somewhere, the user can easily reprint the desired image. As the system needs not to manage information for identifying an image, management in the system is simplified.

As an image taken by a digital camera is usually added with information on shooting date and time as additional information, expiration of each of the images stored in the management server 600 may be managed based on the information on the shooting date and time in the second embodiment as it is done in the first embodiment. That is to say, the management server 600 periodically detects the number of days passed from the shooting date for each of the images stored in the hard disk 616. The management server 600 excludes the image that has passed a preset expiration period from the searching objects or deletes from the hard disk 616. Alternatively, the management server 600 detects the number of days passed from the shooting date of the searched image and if the image is expired, it informs a user that the image is expired. This enables a user to reprint only unexpired images.

As images saved in the management server 600 are added with information on the shooting date like this, the system may be adapted to enable a user to designate a range of shooting dates in searching an image. In such a case, the management server 600 searches the images in the designated range of shooting dates for the target image.

As images are managed in the management server 600 in the abovementioned embodiments, images are not limited to be stored in the server 600. The reception terminal 500 and the management server 600 may be integrated together and the reception terminal 500 may be adapted to manage the images.

In the abovementioned embodiments, the reception terminal 500 is integrated with a digital camera, a scanner, a media reader and a printer, though, each of the components can be separated.

In the abovementioned embodiments, a digital camera, a scanner or the media reader is used as means for inputting a face image, though, a face image can be inputted from the other appliances. A face image can be inputted from a digital camera or a camera cellular phone carried by the user. Means for inputting a face image may be only a digital camera, a scanner or a media reader.

If a face image is inputted from the digital camera 512, the image is more likely to be printed for the first time than to be reprinted; the system may be adapted to obtain a face image of the user by automatically taking a picture of the user's face when the user starts to use the system.

The abovementioned embodiments are described by using the case that the present invention is applied for reprinting a picture for certificate, though, the present invention is not limited to be applied to the case. The present invention can be applied to a case that an image of a particular person is searched from images stored in storage and printed.

The abovementioned embodiments are described by using the case that an image of a particular person is searched and printed, though, the present invention can be applied to a case that an image of an object other than a person is searched and printed.

The abovementioned embodiments are described by using the case that an image of a particular person is searched and printed, though, the present invention can be applied to a case that an image of multiple persons is searched and printed.

When an image of multiple persons is searched and printed, a searching condition can be preferably set. The present invention can be adapted to enable a user to input face images of multiple persons so that an image of all the inputted persons can be searched (so-called AND search). The present invention can be adapted to enable a user to search an image of at least one of the inputted persons (so-called OR search). The present invention can be search an image by combining the AND search and the OR search.

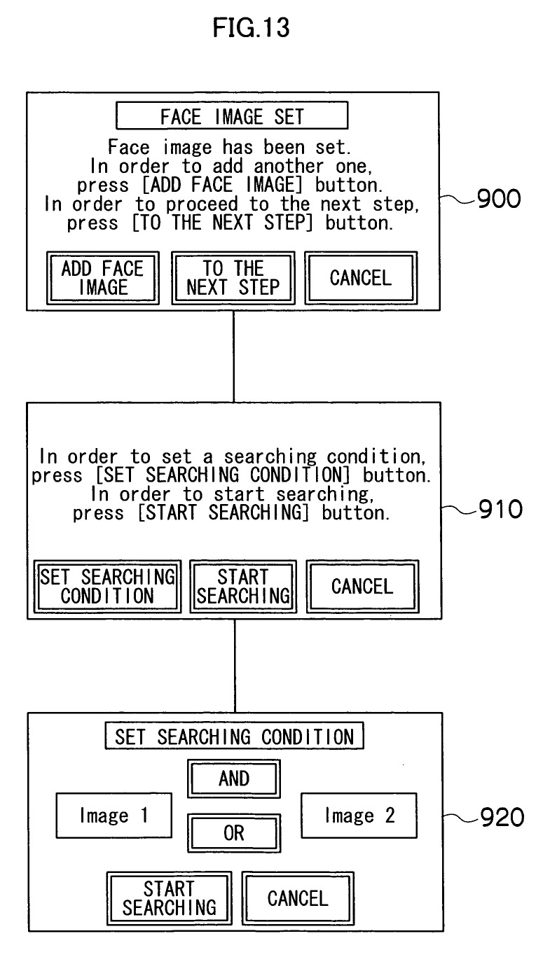

FIG. 13 is a diagram showing an exemplary display of a touch panel of an example of setting a searching condition. When a face image is inputted from a digital camera, a scanner or a medium, a message asking a user if the user wants to add more face image or not is displayed on a touch panel, as shown in numeral 900 in FIG. 13. If the user wants to add a face image, the user presses [ADD FACE IMAGE] button and inputs an additional face image from the digital camera, the scanner or the medium. In order to proceed to the next step, the user presses [TO THE NEXT STEP] button.

When the [TO THE NEXT STEP] button is pressed, a message asking the user if the user wants to set any searching condition or not is displayed on the touch panel, as shown in numeral 910 in FIG. 13 (only in the case the user inputted multiple images). If the user wants to set a searching condition, the user presses [SET SEARCHING CONDITION] button on the screen. If the user wants to start searching without setting a searching condition, the user presses [START SEARCH] button.

When the [SET SEARCHING CONDITION] button is pressed, a screen for a user to set searching conditions is displayed on the touch panel as shown in numeral 920 in FIG. 13. The user sets searching conditions according to the display. The system is adapted to display [AND] button and [OR] button between the inputted two face images, for example, and if the user presses the [AND] button, the search is set to the AND search, and if the user presses the [OR] button, the search is set to the OR search, in this example. When the user sets a searching condition as such and presses the [START SEARCH] button, the search starts.

The present invention enables a user to set searching conditions so that the user can easily find a desired image and print it.

In the abovementioned example, the system is adapted to enable a user to set the AND search or the OR search for a face image, though, it can be adapted to enable a user to set a range of shooting dates as well.

An image to be inputted as a search object is preferably an image of a person, though, an image of multiple persons may be inputted. In such a case, a face image of a person included in the image is automatically extracted for enabling a user to select a face image to be searched.

What is claimed is:

1. A printing method for printing an image of a particular object from images stored in storage, comprising the steps of:
obtaining an image of a particular object to be printed;
extracting the particular object from the obtained image;
searching an image of the extracted object from images stored in the storage; and
printing the searched image.

2. A printing method for printing an image of a particular object from images stored in storage, comprising the steps of:
obtaining a plurality of images of particular objects to be printed;
extracting each of the particular objects from the plurality of obtained images;
searching an image of all the extracted objects from images stored in the storage; and
printing the searched image.

3. A printing method for printing an image of a particular object from images stored in storage, comprising the steps of:
obtaining a plurality of images of particular objects to be printed;
extracting each of the particular objects from the plurality of obtained images;
searching an image of at least one of the extracted objects from images stored in the storage; and
printing the searched image.

4. The printing method according to the claim 1, wherein an image is added with information on shooting date and time and stored in the storage so that an image is searched by an indication of a period of shooting dates and times.

5. The printing method according to the claim 2, wherein an image is added with information on shooting date and time and stored in the storage so that an image is searched by an indication of a period of shooting dates and times.

6. The printing method according to the claim 3, wherein an image is added with information on shooting date and time and stored in the storage so that an image is searched by an indication of a period of shooting dates and times.

7. The printing method according to the claims 1, wherein an image of a particular object to be printed is obtained by being taken by digital camera.

8. The printing method according to the claims 2, wherein an image of a particular object to be printed is obtained by being taken by digital camera.

9. The printing method according to the claims 3, wherein an image of a particular object to be printed is obtained by being taken by digital camera.

10. The printing method according to the claim 1, wherein an image of a particular object to be printed is obtained by being read by scanner.

11. The printing method according to the claim 2, wherein an image of a particular object to be printed is obtained by being read by scanner.

12. The printing method according to the claim 3, wherein an image of a particular object to be printed is obtained by being read by scanner.

13. The printing method according to the claim 1, wherein an image of a particular object to be printed is obtained by being read from a storage medium.

14. The printing method according to the claim 2, wherein an image of a particular object to be printed is obtained by being read from a storage medium.

15. The printing method according to the claim 3, wherein an image of a particular object to be printed is obtained by being read from a storage medium.

16. The printing method according to the claim 1, wherein an image to be stored in the storage is a once printed image.

17. The printing method according to the claim 2, wherein an image to be stored in the storage is a once printed image.

18. The printing method according to the claim 3, wherein an image to be stored in the storage is a once printed image.

19. A printing method for printing an image taken by digital camera, comprising the steps of:
storing an image taken by digital camera in storage;
generating information for identifying the image stored in the storage;
printing the image taken by the digital camera together with the generated information, for printing the image for the first time; and the steps of:
reading the information added to the print and identifying the image to be printed stored in the storage; and
reading out and printing the identified image from the storage, for reprinting the image.

20. The printing method of the claim 1, wherein a stored period of an image in the storage is clocked, and when the stored period is over a certain period, the image is deleted from the storage as an expired image.

21. The printing method of the claim 2, wherein a stored period of an image in the storage is clocked, and when the stored period is over a certain period, the image is deleted from the storage as an expired image.

22. The printing method of the claim 3, wherein a stored period of an image in the storage is clocked, and when the stored period is over a certain period, the image is deleted from the storage as an expired image.

23. The printing method of the claim 19, wherein a stored period of an image in the storage is clocked, and when the stored period is over a certain period, the image is deleted from the storage as an expired image.

24. The printing method according to the claim 20, wherein information to be added to the print includes information on expiration of the image.

25. The printing method according to the claim 1, wherein the size and number to be printed are designated and the image is printed in the indicated size and number.

26. The printing method according to the claim 2, wherein the size and number to be printed are designated and the image is printed in the indicated size and number.

27. The printing method according to the claim 3, wherein the size and number to be printed are designated and the image is printed in the indicated size and number.

28. The printing method according to the claim 19, wherein the size and number to be printed are designated and the image is printed in the indicated size and number.

29. A printing system for printing an image of a particular object from images stored in storage, comprising:
an inputting device for inputting an image of a particular object to be printed;
an extracting device for extracting the particular object from the image inputted by the inputting device;
a searching device for searching an image of the object extracted by the extracting device from images stored in the storage; and
a printing device for printing the image searched by the searching device.

30. The printing system according to the claim 29, wherein when a plurality of images are inputted by the inputting device, the searching device searches an image of all the objects extracted by the extracting device from the images stored in the storage.

31. The printing system according to the claim 29, wherein when a plurality of images are inputted by the inputting device, the searching device searches an image of at least one of objects extracted by the extracting device from the images stored in the storage.

32. The printing system according to the claim 29, further comprising a shooting period inputting device for inputting a shooting period when an image is added with information on the shooting date and time and stored in the storage, wherein the searching device searches a corresponding image from images taken within the shooting period inputted by the shooting period inputting device.

33. The printing systems according to the claim 29, wherein the inputting device is a digital camera.

34. The printing system according to the claim 29, wherein the inputting device is a scanner.

35. The printing system according to the claim 29, wherein the inputting device is a media reader.

36. The printing system according to the claim 29, wherein an image printed by the printing device is stored in the storage.

37. A printing system for printing an image taken by digital camera, comprising:
storage for storing an image taken by digital camera;
an image identifying information generating device for generating information for identifying an image stored in the storage;
a print controlling device for causing a printer to print an image taken by the digital camera together with the information generated by the image identifying information generating device;
an image identifying device for reading the information added to the print and identifying an image to be printed stored in the storage; and
a reprint controlling device for reading an image identified by the image identifying device from the storage and causing a printer to reprint the image.

38. The printing system according to the claim 37, further comprising:
a clocking device for clocking a storage period of an image stored in the storage; and
an image deleting device for deleting an image whose storage period is over a certain period from the storage as an expired image.

39. The printing system according to the claim 38, wherein information generated by the image identifying information generating device includes information on expiration of an image, and wherein the system further comprises:
a determination device for reading information added to a print and determining whether the image to be printed is expired or not; and
a noticing device for noticing a user that the image is expired when the image is determined as expired by the determination device.

40. The printing system according to the claim 37, further comprising an inputting device for inputting the size and the number of print,
wherein the print controlling device and the reprint controlling device cause a printer to print an image in the size and the number inputted by the inputting device.
